(19) United States
(12) Patent Application Publication
(10) Pub. No.: US 2021/0287279 A1
(43) Pub. Date: Sep. 16, 2021

(54) USING SPENDING HABITS TO OPTIMIZE ROUTE IN STORE

(71) Applicant: Capital One Services, LLC, McLean, VA (US)

(72) Inventors: Sam L. TAFFER, McLean, VA (US); Seth Wilton COTTLE, Reston, VA (US); Kathryn TIKOIAN, Arlington, VA (US)

(73) Assignee: Capital One Services, LLC, McLean, VA (US)

(21) Appl. No.: 16/818,732

(22) Filed: Mar. 13, 2020

(51) Int. Cl. G06Q 30/06

(52) U.S. Cl. CPC G06Q 30/0639; G06Q 30/0633

(57) ABSTRACT

A method for route optimization is disclosed. The method may include receiving information of a plurality of transactions of a user. Each transaction may be associated with at least one of a plurality of items. The method may include analyzing the information to identify a user-specific periodic transaction pattern for each item, and generating a list including at least one of the plurality of items. The list may be generated based on the analyzed information. The at least one item in the list may be associated with at least two of the plurality of transactions of the user. The method may further include displaying the list to the user at a time corresponding to the periodic transaction pattern, and generating a route from a current location of the user to a location of each item in the list, ordered based on the location of each item in the list.

### BACKGROUND

Many customers make regular purchases from a store of a retail chain, and often purchase the same items at that store. At most of the store locations, a similar physical layout is maintained that may help the customer to find the item quickly. However, inventory changes and other factors may cause an item to be placed at a different location than its usual place. In some cases, the item may not be available because it is out of stock. Accordingly, it may take longer than usual for the customer to complete the purchase process, even for items that are regularly purchased. Situations like these may lead to inefficient and frustrating shopping experience for many customers. Accordingly, there is a need for a solution to improve user's shopping experience.

### BRIEF SUMMARY

Disclosed herein are a system, method and computer program product embodiments, and/or combinations and sub-combinations thereof, for in-store route optimization based on spending habits of a user.

In an embodiment, a method is disclosed. The method may include steps such as receiving information of a plurality of purchase transactions of a user. Thereafter, the received information of the plurality of purchase transactions of the user may be analyzed to identify a user-specific periodic transaction pattern for each item in the plurality of items. The method may include generating a list, including at least one of the plurality of items. The list may be generated based on the analyzed information, and the at least one item in the list may be associated with at least two of the plurality of transactions of the user. The method may include displaying the list to the user at a time corresponding to the periodic transaction pattern, and generating a route from a current location of the user to each item in the list ordered based on the location of each item in the list.

The method may also include sending one or more query messages to an application server for each item in the list, and receiving one or more responses from the application server. The one or more responses from the application server may include one or more locations of a store where each item in the list may be available. The one or more responses from the application server may also include an identification of the location of each item in the list on a floor-plan of the store. The method may include selecting the location of the store based on user-specified criteria. The user specified criteria may include a price, a day of a week, or a time of day.

For analyzing the information to identify user-specific periodic transaction patterns, the method may include comparing a number of times each item in the plurality of items is included in the plurality of transactions against a configured threshold number. The method may also include determining a number of days between each transaction containing the item, and identifying a period of recurrence for each item in the plurality of transactions to determine the periodic transaction pattern for each item in the plurality of items. The period of recurrence may be weekly, monthly, biweekly, bimonthly, quarterly, semi-annually, yearly, none, or a fixed number of days.

For analyzing the information to identify user-specific periodic transaction patterns, the method may include identifying another item included in a plurality of transactions of another user. The other item may be similar to an item included in the plurality of transactions of the user. The method may include requesting an action from the user to replace the item from the list with the other item in response to one ore more responses from the application server indicating a lack of availability of the item included in the plurality of transactions. For analyzing the information to identify user-specific periodic transaction patterns, the method may also include predicting one or more future transaction dates for each item in the plurality of transactions based on the user-specific periodic transaction pattern for each item in the plurality of transactions. For generating the list, the method may include populating the list based on the predicted one or more future transaction dates for each item in the plurality of transactions. The at least one item in the list may be associated with at least two of the plurality of transactions of the user by being similar to an item included in the at least two of the plurality of transactions.

For generating the route, the method may include determining the current location of the user using data from a global positioning system (GPS) signal. The method may also include providing a first navigation direction from the current location of the user to an entry location of a store containing an item in the list, and providing a second navigation direction from the entry location to a section within the store containing the item in the list.

In another embodiment, a system is disclosed. The system may include a memory for storing instructions and a processor that is communicatively coupled to the memory. The processor may be configured to execute the instructions that may cause the processor to receive information of a plurality of transactions of a user. Each transaction may be associated with at least one of a plurality of items. The processor may be configured to analyze the received information of the plurality of transactions of the user to identify a user-specific periodic transaction pattern for each item in the plurality of items, and generate a list including at least one of the plurality of items. The list may be generated based on the analyzed information, and the at least one item in the list may be associated with at least two of the plurality of transactions of the user. The processor may be configured to display the list to the user at a time corresponding to the periodic transaction pattern, and generate a route from a current location of the user to a location of each item in the list ordered based on the location of each item in the list.

The processor may be configured to send one or more query messages to an application server for each item in the list, and receive one or more responses from the application server. The one or more responses from the application server may include a location of a store where each item in the list may be available. The one or more responses from the application server may also include an identification of the location of each item in the list on a floor-plan of the store. The processor may also be configured to select the location of the store based on user-specified criteria. The user specified criteria may include a price, a day of a week, or a time of day.

To analyze the information to identify the user-specific periodic transaction pattern, the processor may be configured to compare a number of times each item in the plurality of items is included in the plurality of transaction against a configured threshold number, and determine a number of days between each transaction containing the item. The processor may be further configured to identify a period of recurrence for each item in the plurality of transactions to determine the periodic transaction pattern for each item in the plurality of items. The period of recurrence may be weekly, monthly, biweekly, bimonthly, quarterly, semi-annually, yearly, none, or a fixed number of days.

To analyze the information to identify the user-specific periodic transaction pattern, the processor may be configured to identify another item included in a plurality of transactions of another user. The other item may be similar to an item included in the plurality of transactions of the user. The processor may be configured to request an action from the user to replace the item from the list with the other item in response to one or more responses from the application server indicating a lack of availability of the item included in the plurality of transactions.

To analyze the information to identify the user-specific periodic transaction pattern, the processor may be configured to predict one or more future transaction dates for each item in the plurality of transactions based on the user-specific periodic transaction pattern for each item in the plurality of transactions. To generate the list, the processor may be configured to populate the list based on the predicted one or more future transaction dates for each item in the plurality of transactions. The at least one item in the list may be associated with at least two of the plurality of transactions of the user by being similar to an item included in the at least two of the plurality of transactions. To generate the route, the processor may be further configured to determine the current location of the user using data from a global positioning system (GPS) signal. The processor may be further configured to provide a first navigation direction from the current location of the user to an entry location of a store containing an item in the list, and provide a second navigation direction from the entry location to a section within the store containing the item in the list.

In another embodiment, a non-transitory, tangible computer-readable device having instructions stored thereon is disclosed. The instructions when executed by at least one computing device may cause the at least one computing device to perform operations including receiving information of a plurality of purchase transactions of a user. Each transaction may be associated with at least one of a plurality of items. The operations may also include analyzing the information to identify a user-specific periodic transaction pattern for each item in the plurality of items. The operations may also include generating a list including at least one of the plurality of items. The list may be generated based on the analyzed information, and the at least one item in the list may be associated with at least two of the plurality of transactions of the user. The operations may include displaying the list to the user at a time corresponding to the periodic transaction pattern, and generating a route from a current location of the user to each item in the list ordered based on the location of each item in the list.

In yet another embodiment, a user interface is disclosed. The user interface may be configured to receive information identifying a user to locate a user-specific periodic transaction pattern for at least one item in a plurality of transactions associated with the user, and transmit to the user a list including the at least one item in the plurality of transactions. The user interface may also be configured to received from the user another list based on an update to the list by the user, and receive from the user a current location of the user and request to generate a route from the current location of the user. The user interface may also be configured to transmit to the user a first navigation direction from the current location of the user to an entry location of a store containing an item in the other list or an updated list and a second navigation direction from the entry of the store to a section containing the item in the other list or the updated list. The second navigation direction may be based on the location of each item in the other list or the updated list.

### BRIEF DESCRIPTION OF THE DRAWINGS/FIGURES

FIG. 1 illustrates an example network diagram, in accordance with some embodiments.

FIG. 2 illustrates an example server platform, in accordance with some embodiments.

FIG. 3 illustrates a flow chart of steps, in accordance with some embodiments.

FIG. 4 illustrates an example list, in accordance with some embodiments.

FIG. 5 illustrates an example list, in accordance with some embodiments.

FIG. 6 illustrates an example navigation route, in accordance with some embodiments.

FIG. 7 illustrates an example computer system, in accordance with some embodiments.

### DETAILED DESCRIPTION

Provided herein are method, system, and computer program product embodiments, and/or combinations and sub-combinations thereof, for using spending habits determined based on purchase history to optimize routing in store. Accordingly, a list or a shopping list may be automatically generated in a mobile application downloaded by the user on his/her mobile device. The user may update the content of the automatically generated shopping list and request that an optimized route for purchasing the items in the shopping list be generated.

The Summary and Abstract sections may set forth one or more but not all examples of embodiments of the present invention as contemplated by the inventor(s), and thus, are not intended to limit the present invention and the appended claims in any way.

An objective of the present disclosure is, therefore, to automatically generate a shopping list or a list based on spending habits or purchase history of the user and generate an optimized route to navigate the user to the store. The optimized route may also include sections on the store floor-plan where each item in the shopping list may be found in the store such that the shopping may take less time, and the user may spend the saved time on other activities. A user may generally be visiting the same store for purchasing items. Therefore, the user may be familiar with the store layout and may find an item quickly, and the user only occasionally needs to ask where a particular item is located in the store. Most merchants now have a mobile application for their users/customer to download on their mobile devices. Using the mobile application, the user/customer can make payment using a payment method stored in the merchant's mobile application. While there are many benefits for downloading the mobile application for a particular merchant, in accordance with some embodiments, a method and a system to provide an optimized route from a current location of the user to each item in a shopping list may be provided. The shopping list may be generated automatically, as described below. In addition, the user may manually update the automatically generated list to add or remove one or more items to the list.

Many merchants also offer a line of credit by issuing a credit card in partnership with a financial institution. The user may use the merchant's issued credit card to purchase items from the merchant's store only. Accordingly, when a user may be shopping at any store of the merchant at any location and use the merchant-issued credit card, the financial institution may be sent information of the purchase transaction. Generally, such purchase transaction may include the purchase transaction date and time, transaction amount, store location identification. In accordance with some embodiments, when the user purchases at a store using the store issued credit or debit card, details of each purchased item may also be sent to the financial institution. The details of each purchased item may also include the price paid for each item, and stock keeping unit (SKU) number of the purchased item. The details of the purchases made by the user thus may be stored at one or more servers at the merchant. Similarly, the details of the purchases made by the user may also be stored at the one or more servers at the financial institution.

In accordance with some embodiments, the communication of message(s) between the one or more servers at the merchant and the one or more servers at the financial institution may be over a communication network. The communication network may include an Internet, a radio access network communication using 2G, 3G, 4G, 5G, etc., a wireline communication system, a wireless communication system, a satellite communication system, etc. The communication network may allow transmission of the message(s) over a secure network using, for example, IPSec, SSH, virtual private networking (VPN), secured TCP/IP or UDP/IP connection, etc. The communication network may use, for example, hypertext transfer protocol secure (HTTPS) for exchanging communication between the one or more servers at the merchant and the one or more servers at the financial institution.

In accordance with some embodiments, the message(s) exchanged between the one or more servers at the merchant and the one or more servers at the financial institution may be application program interface (API) message(s) over a secure network connection described above. The API message(s) may be a web service message(s) and may be a hypertext transfer protocol (HTTP) or hypertext transfer protocol secure (HTTPS) message(s), a simple object access protocol (SOAP) web service message(s), and/or a representation state transfer (REST) web service message(s). The HTTP/HTTPS, SOAP, and/or REST API message(s) may use GET and/or POST methods. API message(s) using a web service may exchange information including details of the purchase transaction, an automatically generated shopping list, an updated shopping list, inventory for each item in the automatically generated and/or updated shopping list at different stores of the merchant, a current location of the user, etc. The API message(s) using a web service may also exchange information including the current price for each item in the automatically generated and/or updated shopping list at different stores of the merchant. The API message(s) using a web service may also provide store location identifiers and/or a store address for each store where each item in the automatically generated and/or updated shopping list may be available for purchase. Accordingly, the one or more servers at the merchant and/or the one or more servers at the financial institution may be an application server or a backend server for which a frontend is a mobile application downloaded by the user on his/her mobile device.

In accordance with some embodiments, the one or more servers at the merchant may send an API message to the one or more servers at the financial institution when the user makes a purchase at the merchant and makes payment using the merchant-issued credit card being managed by the financial institution. For example, when a user at point of sale in a store of the merchant makes payment using the merchant-issued credit card, an API message including details of each purchased item, a purchase price of each purchased item, store location identifier, purchase date, and/or purchase time may be sent from the point of sale in the store to the one or more servers at the merchant and/or the one or more servers at the financial institution. The one or more servers at the merchant may also store the received information from the point of sale in a database. The one or more servers at the merchant may send the received information from the point of sale to the one or more servers at the financial institution. The one or more servers at the financial institution may also store the received purchase transaction information from the point of sale and/or the one or more servers at the merchant in a database. Accordingly, the one or more servers at the merchant and/or the one or more servers at the financial institutions may analyze the purchase history of the user to identify a user-specific periodic transaction pattern for each item in the plurality of items. In addition, therefore, the one or more servers at the merchant and/or the one or more servers at the financial institutions may act as a backend or an application server for the mobile application, which the user has downloaded on their mobile device.

In accordance with some embodiments, the one or more servers at the merchant and/or the one or more servers at the financial institution may analyze the purchase or transaction history of the user. Accordingly, each item purchased by the user and/or in the plurality of transactions may be analyzed to identify a user-specific periodic transaction pattern or purchase trend. The periodic purchase trend for each item purchased by the user may be identified using machine-learning algorithms. By way of non-limiting example, the analyzing the information to identify the periodic transaction pattern may include determining a number of days between each transaction containing the item. The periodic purchase trend may be identified using supervised and/or unsupervised machine-learning algorithms. Accordingly, an application filed under attorney docket number 4375.0260000 and entitled “A Technique to Aggregate Merchant Level Information for Use in a Supervised Learning Model to Detect Recurring Trends in Consumer Transactions” filed on Oct. 18, 2019 is incorporated herein by reference in its entirety for all purposes. Accordingly, a period of recurrence of purchase for each item may be determined. The determined period of recurrence of purchase for each item purchased by the user may be weekly, monthly, biweekly, bimonthly, quarterly, semi-annually, yearly, none, or a fixed number of days. The period of recurrence identified as ‘none’ indicates that there is no identifiable periodic trend for the item purchased by the user. The identified recurrence period of purchase may be a fixed number of days, for example, every three weeks or 21 days. The item purchased by the user may be analyzed to identify or determine the period or recurrence of purchase if the item has been purchased for a minimum configurable number of times. In other words, the user may specify the minimum configurable number of times, for example, to be two. So if a particular item is purchased only one time, the item may be excluded from the analysis to determine the period or recurrence of purchase.

In accordance with some embodiments, once the period of recurrence for each item purchased by the user is determined, one or more future purchase dates may be predicted. For example, if the period of recurrence for an item-A is determined as weekly, and if the user has last purchased it, for example, on Jun. 10, 2019, the user may likely purchase the item-A on Jun. 17, 2019. The user may also likely purchase the item-A on Jun. 24, 2019. Accordingly, for each item purchased by the user, one or more future purchase dates may be predicted. Therefore, a shopping list or a list may be automatically generated based on the predicted future purchase/transaction dates for each item purchased by the user. Accordingly, when the user logs in to the mobile application, the automatically generated shopping list may be displayed to the user. The automatically generated shopping list may include a list of items that the user may likely purchase based on the identified recurrence period for each item and the purchase history of the user. In addition, the purchase history for a specific period may also be displayed to the user.

In accordance with some embodiments, the user may update the automatically generated shopping list based on the analysis of the user's purchase history and the identified recurrent period for each item purchased by the user. Accordingly, the user may add one or more items to the automatically generated shopping list. The user may also remove one or more items from the automatically generated shopping list. The user may update the quantity of the items in the automatically generated shopping list. The automatically generated shopping list may also include another item in place of the item that the user generally purchases. For example, if the user always buys item-A of brand-A, but other users purchase item-A of brand-B, the shopping may include item-A of brand-B and may include a message that item-A of brand-B is included as a replacement. The user may update the shopping list to select the item-A of brand-A or brand-B.

In accordance with some embodiments, once the user finalizes the automatically generated shopping list, the user may request to generate an optimized route to one or more stores to purchase the items in the finalized shopping list. The mobile application may send a request message to the backend server or the application server to generate a route for the finalized shopping list. Accordingly, the request message from the mobile application to the backend server or the application server may include each item in the finalized shopping list. The request message to generate the optimized route may also include a current location of the user. The application server or the backend server may request one or more servers at the merchant to identify stores based on the current location of the user where each item in the shopping list is available. The application server or the backend server may use a SKU number of each item to obtain details about stores where each item in the shopping list may be available for purchase. The SKU number may be used to identify inventory for the item at different stores. The SKU number may also be used to identify in which section or aisle the item may be found in the store. The SKU number may also provide the current price of the item at different stores. Accordingly, when the request to generate the route is received at the backend server or the application server, the application server may send a query to receive store identifiers or store locations and the section/aisle where each item in the finalized shopping list is available for purchase, current inventory level for each item, and current price for each item.

In accordance with some embodiments, the application server may then generate an optimized route based on user specified criteria. The user specified criteria may include a distance to travel from the current location of the user. The application server may receive the store location as a navigable address. The application server may have store identifiers, and each store identifier may be associated with a navigable address. The application server, therefore, may determine the distance for each store where each item in the finalized shopping list may be available for purchase. The user specified criteria may also include a distance to travel. The user specified criteria may also include the price of the item. The user specified criteria may include a preferred time of day or a preferred day of a week to purchase at a particular store location. The application server may generate the route to a store, which is referenced as a destination store location, from the current location of the user based on the user specified criteria as described above. If not all the items in the finalized shopping list are available at the destination store location, the user may be asked to update the shopping list to remove the items so that user only needs to visit a single store to purchase the items in the shopping list. Alternatively, the application sever may generate the route to one or more destination store locations from the current location of the user, so that the user can complete shopping for all the items in the finalized shopping list.

In accordance with some embodiments, a mobile device using a global positioning system (GPS), Wi-Fi, etc., may determine the current location of the user. The current location of the user may be communicated to the application server using an API message. The application server may cause the mobile application to launch a standard navigation application on the mobile device with the destination address set as an address of the one or more destination store locations. While the user is en route to the one or more destination store locations, the application server can periodically check for any change in the inventory or price for each item in the shopping list with the one or more servers at the merchant. The application server may notify the user if the inventory status or the price of the item in the finalized shopping list changes while the user is en route to the destination store location for shopping. The application server may periodically receive location updates of the user and receive location updates when the user reaches the one or more destination store locations. The application server may display a floor map of the destination store location where the user has arrived. The floor map displayed on the mobile application may include the section and/or aisle where each item in the shopping list may be found. The floor map may also include a recommendation of an order where each item in the shopping list can be purchased for quick shopping. The floor map displayed on the mobile application may also display expected or average shopping time.

As described above, when the user purchases items at the store using the store issued credit card that was managed by a financial institution, details of the entire purchase transaction including a list of all the purchased items may be sent to the financial institution. The merchant would also have details of all the items in the purchase transaction because the merchant sold the items to the user. In accordance with some embodiments, the user may upload the receipt that lists all items purchased as one or more images taken with a camera to the application server via the mobile application. The user may have purchased items using a payment method that does not involve the store issued credit or debit card, such as payment by cash, cheque, another type of credit or debit cards, and/or digital currency such as bitcoin, etc. Further, the purchase transaction analyzed to identify the recurrent period of purchase trend for an item purchased by the user is not limited to the purchase made in-store at the point of sale but may also be an online transaction.

Various embodiments of these features will now be discussed with respect to the corresponding figures.

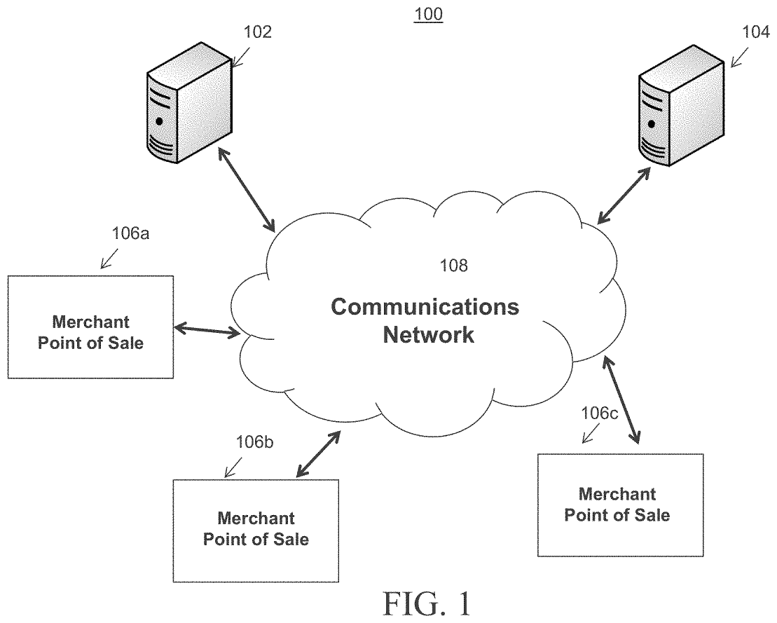

FIG. 1 illustrates a network diagram in accordance with some embodiments. As shown in FIG. 1, a network 100 may include a first server 102, a second server 104, and point of sale devices 106a, 106b, and 106c communicating over a communications network 108. The point of sale devices 106a, 106b, and 106c may be located at different store locations or at the same store location. The user may execute payment at any of the point of sale devices 106a, 106b, and 106c to complete a purchase transaction. Though only three point of sale devices 106a, 106b, and 106c are shown, a person skilled in the art may understand that the disclosure is not limited to only three point of sale devices shown in FIG. 1. The first server 102 may be a server at a merchant and the second server 104 may be a server at a financial institution. Though only one server is displayed at the merchant and the financial institution, there may be more than one server at the merchant and at the financial institution. The server 102 and/or the server 104 may be an application server. The server 102 and/or the server 104 may act as a backend system for a web application or a mobile application. The server 102 and/or the server 104 may also include a database and may be a database server.

As described above, the user may use the merchant's issued credit card to purchase items from the merchant's store and/or an online store of the merchant. Accordingly, when a user may shop at any store of the merchant at any location, the user may use the merchant-issued credit card, for example, at the point of sale device 106a. The point of sale device 106a then may notify the financial institution of the purchase transaction. As described above, such a purchase transaction may include the purchase transaction date and time, transaction amount, and store location identification. In accordance with some embodiments, when the user purchases at a store using the store issued credit or debit card at the point of sale device 106a, in addition to the purchase transaction date and time, transaction amount, and store location identification, the point of sale device 106a may also send details of each purchased item to the server 104 at the financial institution. In addition to the server 104 at the financial institution, the point of sale device 106a may also send the details sent to the server 104 to the server 102 at the merchant. The details of each purchased item may also include the price paid for each item, and stock keeping unit (SKU) number of the purchased item. Accordingly, details of the purchases made by the user may be stored at one or more servers at the merchant and/or the financial institution.

In accordance with some embodiments, the server 102 at the merchant and the server 104 at the financial institution may communicate a message(s) over a communication network 108. The communication network 108 may include an Internet, a radio access network using 2G, 3G, 4G, 5G, etc., a wireline communication system, a wireless communication system, a satellite communication system, etc. The communication network 108 may allow transmission of the message(s) over a secure network using, for example, IPSec, SSH, virtual private networking (VPN), secured TCP/IP or UDP/IP connection, etc. The communication network 108 may use, for example, a hypertext transfer protocol (HTTP) protocol or a hypertext transfer protocol secure (HTTPS) protocol for exchanging communication between the server 102 at the merchant and the server 104 at the financial institution. Though only one server is shown at the merchant and the financial institution in this disclosure, a person skilled in the art may understand that there may be more than one server at the merchant and/or at the financial institution. Accordingly, one or more servers at the merchant and/or at the financial institution may perform the method steps described in this disclosure.

In accordance with some embodiments, the point of sale device 106a may send one or more messages to the server 102 at the merchant and/or the server 104 at the financial institution. The point of sale device 106a may send the one or more messages using, for example, an application program interface (API) message(s) over a secure network connection as described above. The API message(s) may be a web service message(s) and may be a hypertext transfer protocol (HTTP) or hypertext transfer protocol secure (HTTPS) message(s), a simple object access protocol (SOAP) web service message(s), and/or a representation state transfer (REST) web service message(s). The HTTP/HTTPS, SOAP, and/or REST API message(s) may use GET and/or POST methods. The point of sale device 106a may send details of the purchase transaction using the API message(s) to the server 102 and/or the server 104. The details of the purchase transaction may include the purchase date, the purchase time, an SKU of each item purchased by the user, and/or the price paid for each item purchased by the user in this purchase transaction. The details of the purchase transaction may also include a method of payment, which may be cash, credit or debit card, cheque, and/or another type of digital currency.

In accordance with some embodiments, the server 102 and the server 104 may also exchange one or more API messages using web services. The one or more API messages may include details of the purchase transaction, an automatically generated shopping list, an updated shopping list, inventory for each item in the automatically generated and/or updated shopping list at different stores of the merchant, a current location of the user, etc. The API messages may also include the current price for each item in the automatically generated and/or updated shopping list at different stores of the merchant. The API messages may also include store location identifiers and/or a store address for each store where each item in the automatically generated and/or updated shopping list may be available for purchase. Accordingly, the server 102 at the merchant and/or the server 104 at the financial institution may be an application server or a backend server for which a frontend is a mobile application downloaded by the user on his/her mobile device. The mobile device may be a mobile phone, a smartphone, a tablet, a computer, etc.

In accordance with some embodiments, the server 102 at the merchant may send one or more API messages to the server 104 at the financial institution or vice versa when the user completes a purchase with the merchant and makes a payment using the merchant-issued credit or debit card being managed by the financial institution. For example, when a user at the point of sale device 106a in a store of the merchant makes a payment using the merchant-issued credit card, an API message including details of each purchased item, a purchase price of each purchased item, a store location identifier, a purchase date, and/or a purchase time may be sent from the point of sale in the store to the server 102 at the merchant and/or the server 104 at the financial institution. In some embodiments, the point of sale device 106a may send details of purchase transaction to the server 102 only. The server 102 may then send the information received from the point of sale device 106a to the server 104. In some embodiments, the point of sale device 106a may send details of the purchase transaction to the server 104 only. The server 104 may then send the information received from the point of sale device 106a to the server 102. The server 102 and/or the server 104 may store the received information from the point of sale in one or more databases. Accordingly, the server 102 at the merchant and/or the server 104 at the financial institutions may analyze the purchase history of the user. In addition, therefore, the server 102 at the merchant and/or the server 104 at the financial institutions may act as a backend or an application server for the mobile application, which the user has downloaded on their mobile device.

In accordance with some embodiments, the server 102 and/or the server 104 may analyze the purchase history of the user or the plurality of transactions of the user received at the server 102 and/or the server 104. Accordingly, the server 102 and/or the server 104 may analyze the plurality of transactions to identify a user-specific periodic transaction pattern or a user-specific periodic purchase trend for each item in the plurality of items. By way of non-limiting example, the user-specific periodic transaction pattern may be determined by determining a number of days between each transaction containing the item when the item is included in the plurality of transactions at least a number of times that may be equal or more than a configurable threshold number of times. The periodic purchase trend for each item purchased by the user may be identified using machine-learning algorithms. The periodic purchase trend may be identified using supervised and/or unsupervised machine-learning algorithms. A patent application filed under attorney docket number 4375.0260000 and entitled “A Technique to Aggregate Merchant Level Information for Use in a Supervised Learning Model to Detect Recurring Trends in Consumer Transactions” filed on Oct. 18, 2019, incorporated herein by reference in its entirety, discloses an example method of identifying a periodic purchase trend. Accordingly, a period of recurrence of purchase for each item may be determined.

The determined period of recurrence of purchase/transaction for each item purchased by the user may be weekly, monthly, biweekly, bimonthly, quarterly, semi-annually, yearly, none, or a fixed number of days. The period of recurrence identified as ‘none’ indicates that there is no identifiable periodic trend for the item purchased by the user. The identified recurrence period of purchase may be a fixed number of days, for example, every three weeks or 21 days. The item purchased by the user may be analyzed to identify or determine the period or recurrence of purchase if the item has been purchased for a minimum configurable number of times. In other words, the user may specify the minimum configurable number of times, for example, to be two. So if a particular item is purchased only one time, the item may be excluded from the analysis to determine the period of recurrence of purchase. For the item excluded from the analysis to determine the period of recurrence of purchase, the period of recurrence for purchase may be set to ‘none.’

In accordance with some embodiments, the server 102 and/or the server 104 may predict a future purchase/transaction date for each item in the plurality of items in the plurality of transactions or for each item purchased by the user based on the period of recurrence of purchase. For example, if the period of recurrence for an item-A is determined as weekly, and if the user has last purchased it, for example, on Jun. 10, 2019, the user may likely purchase the item-A on Jun. 17, 2019. The user may also likely purchase the item-A on Jun. 24, 2019. Accordingly, for each item purchased by the user, one or more future purchase dates may be predicted. Therefore, a shopping list may be automatically generated based on the predicted future purchase dates for each item purchased by the user. Accordingly, when the user logs in to the mobile application, the automatically generated shopping list may be displayed to the user. The automatically generated shopping list may include a list of items that the user may likely purchase based on the identified recurrence period for each item and the purchase history of the user. In addition, the purchase history for a specific period may also be displayed to the user.

In accordance with some embodiments, the server 102 and/or the server 104 may also identify another item included in a plurality of transactions of another user for analyzing the information to identify the user-specific periodic transaction pattern. Accordingly, when a query response indicates that the item populated in the list is unavailable at the store, the server 102 and/or the server 104 may suggest a replacement item to the user. The replacement item may be similar to another item purchased by another user.

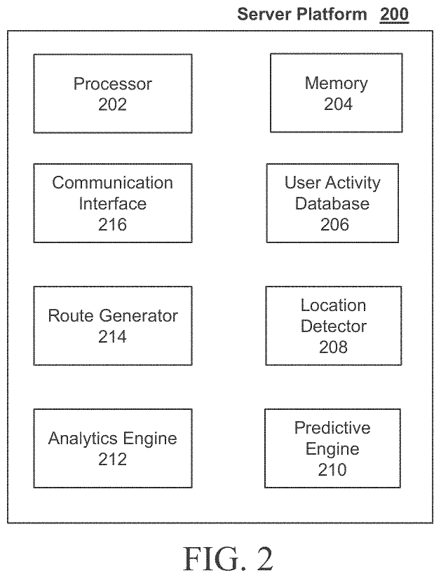

FIG. 2 illustrates an example server platform, in accordance with some embodiments. As shown in FIG. 2, the server platform 200 includes a processor 202, a memory 204, a user activity database 206, a location detector 208, a predictive engine 210, an analytics engine 212, a route generator 214, and a communication interface 216. Though only one element for each server component is shown in FIG. 2, a person skilled in the art may know that there may be more than one element for each server component. Accordingly, there may be two processors or two communication interfaces. Memory 204 may store computer instructions or operations to be performed by the processor 202 as described herein. The user activity database 206 may store the plurality of transactions received by the server, where each transaction may be a purchase transaction and may include information as described above.

The analytics engine 212 may analyze the plurality of transactions to identify a user-specific periodic transaction pattern as described herein, and to generate a list of items based on the identified period of recurrence for each item in the plurality of items. The predictive engine 210 may generate future transaction or purchase dates for each item according to the period of recurrence identified by the analytics engine. Based on the future transaction date predicted for each item in the plurality of items, a list or a shopping list for the user may be automatically generated and may be sent to the user over the communication interface 216. The communication interface 216 thus connects the server platform 200 with the communications network 108.

The communication interface 216 also acts a user interface that receives information identifying a user to locate a user-specific periodic transaction pattern for at least one item in a plurality of transactions associated with the user. The communication interface 216 transmits the automatically generated list based on an analysis of the plurality of transactions to identify the user-specific periodical transaction pattern. The communication interface 216 also receives from the user an updated list that has been modified by the user to add or remove an item, or update a quantity for an item in the list. The communication interface 216 also receives from the user a current location of the user and a request to generate a route to the store(s) for each item in the automatically generated list. The communication interface may also send to the user a first navigation direction, from the current location of the user to an entry location of a store containing an item in the updated list received from the user, and a second navigation direction, from the entry location of the store to a section within the store containing the item in the updated list.

The location detector 208 may be a database that stores a current location of each user of the mobile application as identified based on the plurality of transactions. The location detector 208 may also include locations of different stores and a location of an item on the store floor-plan. The route generator 214 may generate a route based on a current location of a user relative to a store based on the items in the list. The route generator 214 may generate and transmit to the user either static or dynamic navigation directions over the communication interface 216.

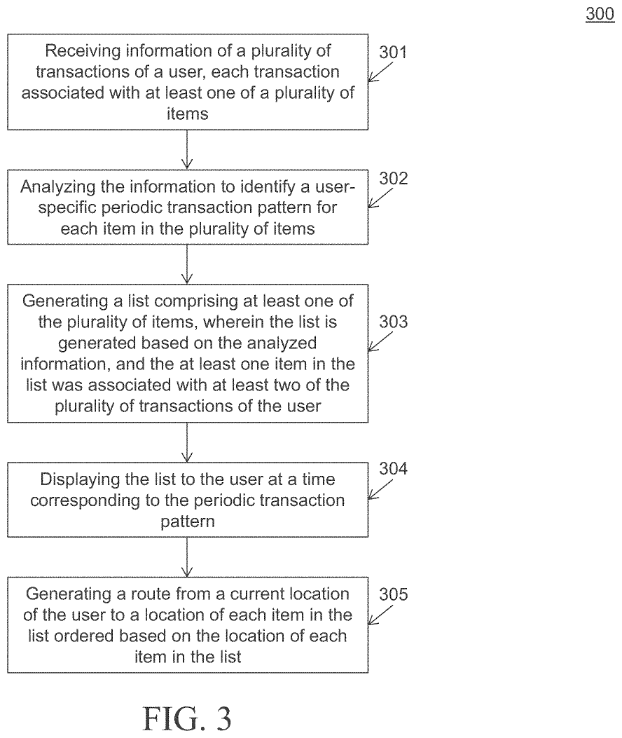

FIG. 3 illustrates a flow chart of steps, in accordance with some embodiments. At step 301, the server 102 and/or the server 104 may receive information of a plurality of transactions of a user, where each transaction may be associated with at least one of a plurality of items. The plurality of transactions of a user may be the purchase transactions of the user. The user may complete a purchase at the point of sale device 106a. The transaction information may be sent from the point of sale device 106a to the server 102 and/or the server 104 over the communications network 108. As described above, the received information of the purchase transaction may include a purchase date and/or purchase time, a list of each item in the purchase transaction, an associated SKU number, and a price paid for each item. The received information of the purchase transaction may also include a method of payment. The method of payment as described above may be cash, cheque, a credit or a debit card, and/or another type of currency. As described above, the credit or debit card may be issued by the merchant and may be managed by the financial institution. The server 102 and/or the server 104 may store the received purchase transaction information in a database. As described above, the server 102 and/or the server 104 may also receive purchase transaction information from a user. The user may upload an image of the purchase receipt or similar document to the server 102 and/or the server 104. The user may also create a record of purchase transaction manually by entering details of each item purchased. The server 102 and/or the server 104 may store the received purchase transactions information in the database.

At step 302, in accordance with some embodiments, the server 102 and/or the server 104 may analyze the information to identify a user-specific periodic transaction pattern for each item in the plurality of items. The plurality of transactions may be stored in the user activity database 206, and may be analyzed to identify a periodic purchase trend or periodic transaction pattern for each item in the plurality of items. The server 102 and/or the server 104 may analyze the plurality of transactions including records of stored purchase transactions in the database using a machine-learning algorithm(s). The machine-learning algorithm(s) may be supervised and/or unsupervised machine-learning algorithm(s), as described above. Accordingly, a period of recurrence of purchase for each item may be determined. As described above, the server 102 and/or the server 104 may determine the period of recurrence of purchase for an item if it is purchased at least a configurable minimum number of times. For example, if the minimum number of times is set to two, then an item purchased only once is excluded from the analysis to determine the period of recurrence of purchase. Accordingly, the period of recurrence of purchase for the item purchased only once is set to ‘none.’ The server 102 and/or the server 104 may periodically analyze the purchase history to update or determine the period of recurrence of purchase.

At step 303, in accordance with some embodiments, the server 102 and/or the server 104 may automatically generate a list including at least one of the plurality of items. The list may be generated based on the analyzed information. The at least one item in the list may be associated with at least two of the plurality of transactions of the user. In other words, each item in the automatically generated list is purchased at least 2 times by the user. The shopping list may be populated based on the period of recurrence of purchase identified for each item. Based on the period of recurrence of purchase/transaction as identified for each item, a future purchase/transaction date(s) may be predicted for each item. Accordingly, the server 102 and/or the server 104 may automatically generate the shopping list or the list based on the predicted future purchase/transaction date(s).

At step 304, in accordance with some embodiments, when the user logs in to the mobile application, which the user has downloaded on his/her mobile device, the server 102 and/or the server may cause the automatically generated list or shopping list to be displayed on the mobile device of the user. The server 102 and/or the server 104 may push the automatically generated list to the mobile device over the communications network 108 using an API message(s). The server 102 and/or the server 104 may also transmit the automatically generated list via an email to the user. The user may then update the automatically generated list to add one or more items to, or remove one or more items from, the list. The user may update the automatically generated list to update a quantity for each item in the shopping list. In other words, the user may finalize the automatically generated list.

At step 305, in accordance with some embodiments, once the user has finalized the automatically generated list, the user may request the server 102 and/or the server 104 to generate a route for each item in the finalized list. The user may click an option on the mobile application to generate the optimized route. The mobile application may send an API message(s) to the server 102 and/or the server 104 to generate the optimized route for the finalized shopping list. A person skilled in the art would understand that as the user is updating the automatically generated shopping list on his/her mobile application, the mobile device may communicate with the server 102 and/or the server 104 to update the automatically generated shopping list. An optimized route may be generated for each item in the shopping list. The mobile device of the user may also send current location information to the server 102 and/or the server 104 when the user requests generation of the optimized route.

The server 102 and/or the server 104 may query an appropriate database or another server to request store locations where each item in the finalized shopping list may be available for purchase. The server 102 and/or the server 104 may use the received current location information from the mobile device of the user to generate the optimized route from the current location of the user. The server 102 and/or the server 104 may compute the distance from the current location of the user to each store where each item in the finalized shopping list may be available for purchase. The server 102 and/or the server 104 may use the SKU to query the store location where each item may be available. Based on the SKU of each item, the server 102 and/or the server 104 may also receive information for each item, such as an available inventory, a purchase price, and/or an aisle or a section of the store where the item may be found. The server 102 and/or the server 104 may consider user configurable options such as distance to travel, preferred store location, price of the item, time of day, and/or day of a week. Examples of other configurable options may be the price of each item to be purchased. For example, the total cost to purchase all items in the finalized shopping list may be considered. The configurable options to generate the optimized route may also include a preferred time of a day and/or a preferred day of a week for shopping. Based on the configurable options, the server 102 and/or the server 104 may determine the store location, which may be referenced as a destination store location. The server 102 and/or the server 104 may then generate the optimized route as a route from the current location of the user to the destination store location. If not all items from the finalized shopping list are available at a single destination store location, the server 102 and/or the server 104 may generate the optimized route as a route from the current location of the user to more than one destination store locations. Alternatively, the user may update the shopping list such that the user may complete shopping by visiting only one destination store location.

In accordance with some embodiments, at step 305, the server 102 and/or the server 104 may cause the mobile application on the mobile device of the user to launch a standard navigation application with the destination address set as an address of the one or more destination store locations. The starting address may be set as the current location of the mobile device as detected by the mobile device using a GPS and/or a Wi-Fi signal, etc. While the user is en route to the one or more destination store locations, the server 102 and/or the server 104 may periodically check for any change in the inventory or price for each item in the shopping list. The server 102 and/or the server 104 may notify the user if the inventory status or the price of the item in the finalized shopping list has changed while the user is en route to the destination store location for shopping. The server 102 and/or the server 104 may periodically receive location updates of the user, including a location update when the user reaches the one or more destination store locations. The server 102 and/or the server 104 may display a floor map of the destination store location where the user has arrived. The floor map displayed on the mobile application may include the section and/or aisle where each item in the shopping list may be found. The floor map may also include a recommendation of an order in which to purchase each item in the shopping list for quick shopping. The floor map displayed on the mobile application may also display an expected or average shopping time.

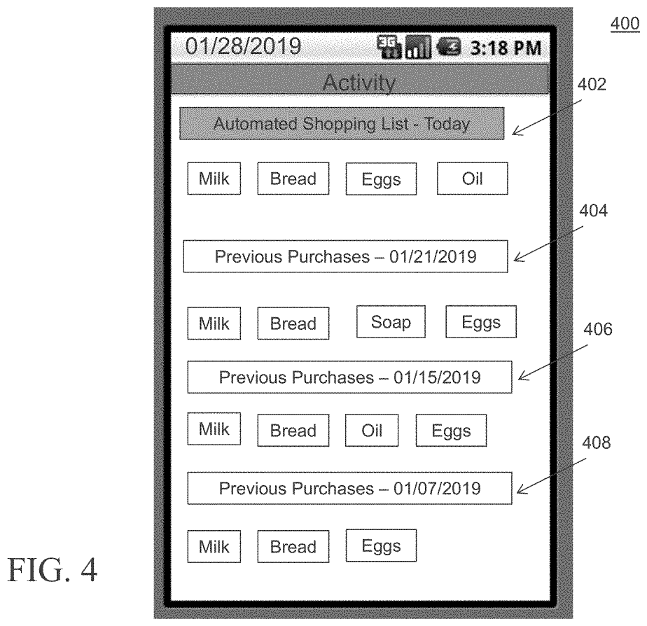

FIG. 4 illustrates an example of shopping list, in accordance with some embodiments. As shown in FIG. 4, a screen of the mobile application 400 on the user device shows automatically generated shopping list 402 as described above. Previous purchase histories 404, 406, and 408 of the user are also shown. The automatically generated shopping list 402 for a specific day, for example, today, may include items as determined based on the predicted future purchase date(s) as described above.

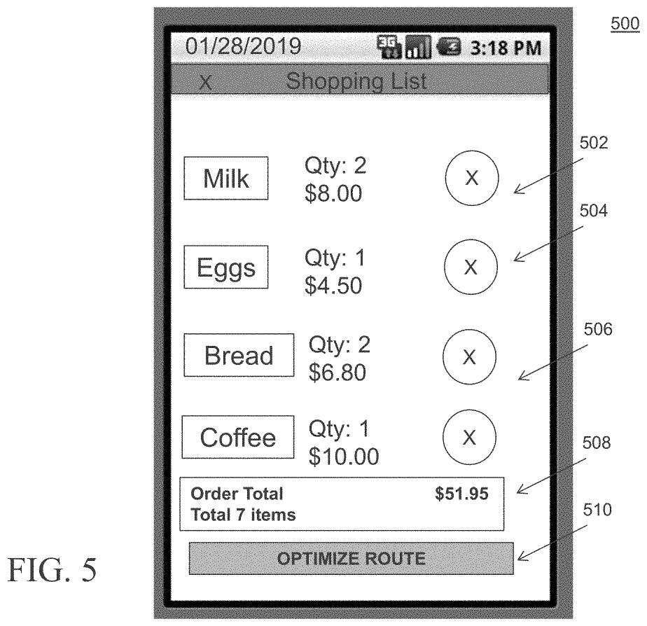

FIG. 5 illustrates an example of shopping list, in accordance with some embodiments. As shown in FIG. 5, a screen of the mobile application 500 shows a list of items 502, 504, and 506 in the automatically generated shopping list 402. The screen 500 may show a partial list and the user may see the complete list by scrolling up/down. The screen 500 may also show a total number of items in the automatically generated shopping list 402 and a total purchase price. The screen 500 may also show an option to generate an optimized route, shown in the screen 500 as ‘Optimize Route’ 510. When the user selects or clicks on the ‘Optimize Route’ 510, the mobile device may send an API message to the server 102 and/or the server 104 to generate the optimized route as described above.

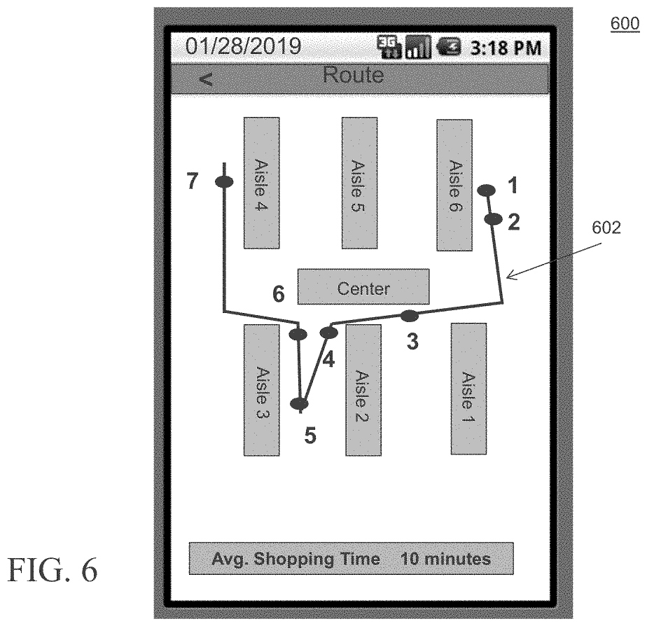

FIG. 6 illustrates an example navigation route, in accordance with some embodiments. While an actual turn-by-turn route is not shown here, a person skilled in the art may integrate a native mobile application to provide to the user turn-by-turn route guidance from the starting address to the one or more destination store locations. Once the user reaches the destination store location, the server 102 and/or the server 104 may generate a floor map of the destination store location 600 superimposed with a recommended order and route to purchase 602 as shown in FIG. 6. The server 102 and/or the server 104 may generate the floor map of the destination store location 500 as described above.

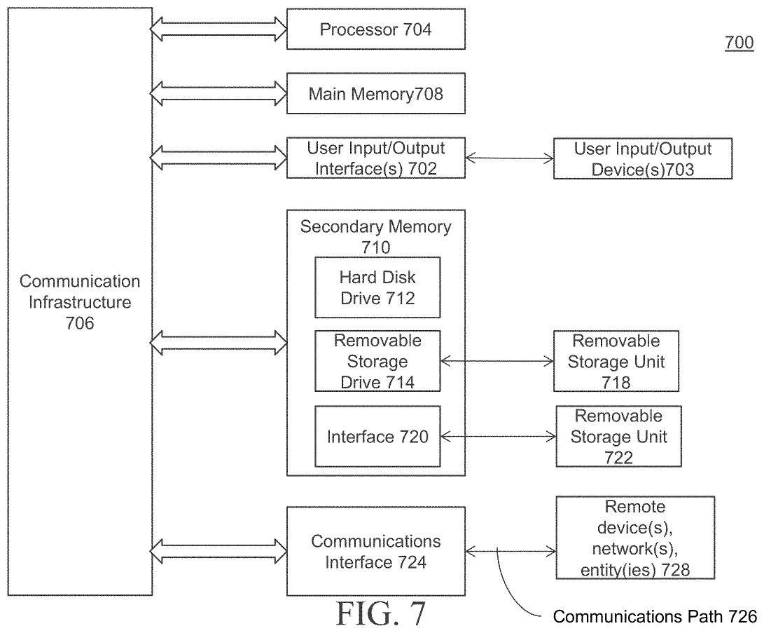

FIG. 7 illustrates an exemplary computer system, in accordance with some embodiments.

Various embodiments may be implemented, for example, using one or more well-known computer systems, such as a computer system 700 as shown in FIG. 7. One or more computer systems 700 may be used, for example, to implement any of the embodiments discussed herein, as well as combinations and sub-combinations thereof. The computer systems 700 may be used for the server 102 and/or the server 104 described above.

The computer system 700 may include one or more processors (also called central processing units, or CPUs), such as a processor 704. The processor 704 may be connected to a communication infrastructure or bus 706.

The computer system 700 may also include user input/output device(s) 703, such as monitors, keyboards, pointing devices, etc., which may communicate with communication infrastructure 706 through user input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

The computer system 700 may also include a main or primary memory 708, such as random access memory (RAM). Main memory 708 may include one or more levels of cache. Main memory 708 may have stored therein control logic (i.e., computer software) and/or data.

The computer system 700 may also include one or more secondary storage devices or memory 710. The secondary memory 710 may include, for example, a hard disk drive 712 and/or a removable storage device or drive 714. The removable storage drive 714 may be a floppy disk drive, a magnetic tape drive, a compact disk drive, an optical storage device, tape backup device, and/or any other storage device/drive.

The removable storage drive 714 may interact with a removable storage unit 718. The removable storage unit 718 may include a computer usable or readable storage device having stored thereon computer software (control logic) and/or data. The removable storage unit 718 may be a floppy disk, magnetic tape, compact disk, DVD, optical storage disk, and/any other computer data storage device. The removable storage drive 714 may read from and/or write to the removable storage unit 718.

The secondary memory 710 may include other means, devices, components, instrumentalities or other approaches for allowing computer programs and/or other instructions and/or data to be accessed by the computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

The computer system 700 may further include a communication or network interface 724. The communication interface 724 may enable the computer system 700 to communicate and interact with any combination of external devices, external networks, external entities, etc. (individually and collectively referenced by reference number 728). For example, the communication interface 724 may allow the computer system 700 to communicate with the external or remote devices 728 over communications path 726, which may be wired and/or wireless (or a combination thereof), and which may include any combination of LANs, WANs, the Internet, etc. Control logic and/or data may be transmitted to and from the computer system 700 via the communication path 726.

The computer system 700 may also be any of a personal digital assistant (PDA), desktop workstation, laptop or notebook computer, netbook, tablet, smartphone, smartwatch or other wearable, appliance, part of the Internet-of-Things, and/or embedded system, to name a few non-limiting examples, or any combination thereof.

The computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in the computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats, or schemas may be used, either exclusively or in combination with known or open standards.

In accordance with some embodiments, a tangible, non-transitory apparatus or article of manufacture may include a tangible, non-transitory computer useable or readable medium having control logic (software) stored thereon may also be referred to herein as a computer program product or program storage device. This includes, but is not limited to, the computer system 700, the main memory 708, the secondary memory 710, and the removable storage units 718 and 722, as well as tangible articles of manufacture embodying any combination of the foregoing. Such control logic, when executed by one or more data processing devices (such as the computer system 700), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described examples of embodiments, but should be defined only in accordance with the following claims and their equivalents.

1. A method for route optimization, comprising:
receiving information of a plurality of transactions of a user, each transaction associated with at least one of a plurality of items;
analyzing the information to identify a user-specific periodic transaction pattern for each item in the plurality of items;
automatically generating a list comprising a subset of the plurality of items, wherein the list is generated based on the analyzed information, and wherein each item in the list is associated with at least two of the plurality of transactions of the user;
displaying the automatically generated list to the user for finalizing the automatically generated list;
receiving from the user a finalized list based on the automatically generated list;
in response to a request from the user to generate a route corresponding to the finalized list, periodically checking for availability of all items in the finalized list at a single store location;
in response to all items in the finalized list being unavailable at the single store location, requesting the user to modify the finalized list such that each item in a modified finalized list is available at the single store location; and
generating a route from a current location of the user to a location of each item in the modified finalized list ordered based on the location of each item in the modified finalized list being at the single store location.

2. The method of claim 1, further comprising:
sending one or more query messages to an application server for each item in the finalized list; and
receiving one or more responses from the application server, wherein the one or more responses comprise the store location where each item in the finalized list is available.

3. The method of claim 2, wherein the one or more responses further comprise an identification of the location of each item in the modified finalized list on a floor plan of the single store location.

4. The method of claim 2, further comprising:
selecting the store location based on user specified criteria, wherein the user specified criteria comprises a price, a day of a week, or a time of day.

5. The method of claim 1, wherein the analyzing comprises:
comparing a number of times each item in the plurality of items is included in the plurality of transactions against a configured threshold number;
determining a number of days between each transaction containing the item; and
identifying a period of recurrence for each item in the plurality of transactions to determine the periodic transaction pattern for each item in the plurality of items,
wherein the period of recurrence is weekly, monthly, biweekly, bimonthly, quarterly, semi-annually, yearly, none, or a fixed number of days.

6. The method of claim 1, wherein the analyzing comprises:
identifying another item included in a plurality of transactions of another user, wherein the other item is similar to an item included in the plurality of transactions of the user; and
requesting an action from the user to replace the item from the automatically generated list or the finalized list with the other item in response to one or more responses from the application server indicating a lack of availability of the item included in the plurality of transactions.

7. The method of claim 1,
wherein the analyzing comprises predicting one or more future transaction dates for each item in the plurality of transactions based on the user-specific periodic transaction pattern for each item in the plurality of transactions; and
wherein the automatically generating the list comprises populating the list based on the predicted one or more future transaction dates for each item in the plurality of transactions.

8. The method of claim 1,
wherein the at least one item in the automatically generated list is associated with at least two of the plurality of transactions of the user by being similar to an item included in the at least two of the plurality of transactions.

9. The method of claim 1, wherein the generating the route comprises:
determining the current location of the user using data from a global positioning system (GPS) signal;
providing a first navigation direction from the current location of the user to an entry location of the single store location; and
providing a second navigation direction from the entry location of the single store location to a section within the single store location containing the item in the modified finalized list.

10. A system, comprising:
a memory for storing instructions; and
a processor, communicatively coupled to the memory, configured to execute the instructions, the instructions causing the processor to:
receive information of a plurality of transactions of a user, each transaction associated with at least one of a plurality of items;
analyze the information to identify a user-specific periodic transaction pattern for each item in the plurality of items;
automatically generate a list comprising a subset of the plurality of items, wherein the list is generated based on the analyzed information, and wherein each item in the list is associated with at least two of the plurality of transactions of the user;
display the automatically generated list to the user for finalizing the automatically generated list;
receive from the user a finalized list based on the automatically generated list;
in response to a request from the user to generate a route corresponding to the finalized list, periodically check for availability of all items in the finalized list at a single store location;
in response to all items in the finalized list being unavailable at the single store location, request the user to modify the finalized list such that each item in a modified finalized list is available at the single store location; and
generate a route from a current location of the user to a location of each item in the modified finalized list ordered based on the location of each item in the modified finalized list being at the single store location.

11. The system of claim 10, wherein the processor is further configured to:
send one or more query messages to an application server for each item in the finalized list; and
receive one or more responses from the application server, wherein the one or more responses comprise the store location where each item in the list is available.

12. The system of claim 11, wherein the one or more responses further comprise an identification of the location of each item in the modified finalized list on a floor plan of the single store location.

13. The system of claim 11, wherein the processor is further configured to:
select the store location based on user specified criteria, wherein the user specified criteria comprises a price, a day of a week, or a time of day.

14. The system of claim 10, wherein to analyze the information, the processor is further configured to:
compare a number of times each item in the plurality of items is included in the plurality of transactions against a configured threshold number;
determine a number of days between each transaction containing the item; and
identify a period of recurrence for each item in the plurality of transactions to determine the periodic transaction pattern for each item in the plurality of items,
wherein the period of recurrence is weekly, monthly, biweekly, bimonthly, quarterly, semi-annually, yearly, none, or a fixed number of days.

15. The system of claim 10, wherein to analyze the information, the processor is further configured to:
identify another item included in a plurality of transactions of another user, wherein the other item is similar to an item included in the plurality of transactions of the user; and
request an action from the user to replace the item from the automatically generated list or the finalized list with the other item in response to one or more responses from the application server indicating a lack of availability of the item included in the plurality of transactions.

16. The system of claim 10, wherein the processor is further configured to:
wherein to analyze, the processor is further configured to predict one or more future transaction dates for each item in the plurality of transactions based on the user-specific periodic transaction pattern for each item in the plurality of transactions; and
wherein to automatically generate the list, the processor is further configured to populate the list based on the predicted one or more future transaction dates for each item in the plurality of transactions.

17. The system of claim 10, wherein the at least one item in the automatically generated list is associated with at least two of the plurality of transactions of the user by being similar to an item included in the at least two of the plurality of transactions.

18. The system of claim 10, wherein to generate the route, the processor is further configured to:
determine the current location of the user using data from a global positioning system (GPS) signal;
provide a first navigation direction from the current location of the user to an entry location of the single store location; and
provide a second navigation direction from the entry location of the single store location to a section within the single store location containing the item in the modified finalized list.

19. A non-transitory, tangible computer-readable device having instructions stored thereon that, when executed by at least one computing device, causes the at least one computing device to perform operations comprising:
receiving information of a plurality of transactions of a user, each transaction associated with at least one of a plurality of items;
analyzing the information to identify a user-specific periodic transaction pattern for each item in the plurality of items;
automatically generating a list comprising a subset of the plurality of items, wherein the list is generated based on the analyzed information, and wherein each item in the list is associated with at least two of the plurality of transactions of the user;
displaying the automatically generated list to the user for finalizing the automatically generated list;
receiving from the user a finalized list based on the automatically generated list;
in response to a request from the user to generate a route corresponding to the finalized list, periodically checking for availability of all items in the finalized list at a single store location;
in response to all items in the finalized list being unavailable at the single store location, requesting the user to modify the finalized list such that each item in a modified finalized list is available at the single store location; and
generating a route from a current location of the user to a location of each item in the modified finalized list ordered based on the location of each item in the modified finalized list being at the single store location.

20. A user device configured to:
receive information identifying a user to locate a user-specific periodic transaction pattern for a subset of items of a plurality of items corresponding to a plurality of transactions associated with the user;
transmit to the user an automatically generated list comprising the subset of items based on the plurality of transactions for finalizing the automatically generated list;
in response to a request from the user to generate a route corresponding to a finalized list, periodically check for availability of all items in the finalized list at a single store location;
in response to all items in the finalized list being unavailable at the single store location, display to the user a request to modify the finalized list such that each item in a modified finalized list is available at the single store location;
transmit to the user first navigation direction from a current location of the user to an entry location of the single store location; and
transmit to the user second navigation direction from the entry location of the single store location to a section within the single store location,
wherein the second navigation direction is based on the location of each item in the modified finalized-list.
